(19) United States
(12) Patent Application Publication
(10) Pub. No.: US 2026/0152272 A1
(43) Pub. Date: Jun. 4, 2026

(54) FLEXIBLE PRESSURIZATION BULKHEAD FOR AN AIRCRAFT

(71) Applicant: Airbus Operations SAS, TOULOUSE (FR)

(72) Inventors: Patrick LIEVEN, TOULOUSE (FR); Anthony MERTES, TOULOUSE (FR)

(21) Appl. No.: 19/401,583

(22) Filed: Nov. 26, 2025

(30) Foreign Application Priority Data
Nov. 29, 2024 (FR) FR2413232

(51) Int. Cl. B64C 1/10

(52) U.S. Cl. CPC B64C 1/10

(57) ABSTRACT

A pressurization bulkhead for an aircraft includes a membrane having a plane main surface and an articulation for connecting the membrane to the fuselage of the aircraft. The articulation is a pivot. A flexible liner is rigidly attached to the articulation and extends between the membrane and the articulation. The membrane has a circular contour.

### CROSS-REFERENCES TO RELATED APPLICATIONS

This Application claims the benefit of French Patent Application Number 2413232 filed on Nov. 29, 2024, the entire disclosure of which is incorporated herein by way of reference.

### FIELD OF THE INVENTION

The present invention relates to a pressurization bulkhead for an aircraft.

### BACKGROUND OF THE INVENTION

In an effort to reduce the climatic impact of aviation the Proprietor has developed aircraft projects in which the engines function with propulsion by hydrogen. This type of propulsion necessitates specific equipment, in particular one or more tanks containing hydrogen, preferably in liquid form and at cryogenic temperature in order to increase its density and to reduce the volume necessary for its storage. The hydrogen tanks are preferably disposed in the rear of the aircraft, behind the aft pressurization bulkhead. The aft pressurization bulkhead, which is generally dome-shaped, forms a barrier between the cabin which is pressurized in flight and the rear of the aircraft which is not pressurized.

However, hydrogen tanks are bulky and shift the center of gravity of the aircraft toward the rear, which impacts the design of the structure of the aircraft itself.

The object of the invention is to remedy this disadvantage at least partially.

### SUMMARY OF THE INVENTION

To this end there is proposed a pressurization bulkhead for an aircraft including a membrane having a plane main surface and at least one articulation for connecting the membrane to the fuselage of the aircraft.

The bulkhead according to the present invention saves space because of its flat shape, which also makes it possible to move the hydrogen tanks toward the center of the aircraft. The bulkhead according to the invention offers optimized behavior in the event of deformation thanks to the articulations, which prevents the appearance of a moment where the membrane is fixed to the fuselage of the aircraft.

In accordance with another aspect said at least one articulation is a pivot.

In accordance with another aspect the bulkhead includes a flexible liner rigidly attached to said at least one articulation and extending between the membrane and said at least one articulation.

In accordance with another aspect the membrane has a circular contour, the bulkhead including at least two articulations regularly distributed around said circular contour.

In accordance with another aspect the bulkhead includes eight articulations regularly distributed around said circular contour.

In accordance with another aspect the bulkhead includes at least one radial reinforcement.

In accordance with another aspect the bulkhead includes at least one radial reinforcement associated with each articulation.

In accordance with another aspect each radial reinforcement is a metal or composite material bar.

In accordance with another aspect the membrane includes a stack of layers including at least one layer of cardboard honeycomb and/or of foam and at least one layer of composite material.

In accordance with another aspect the bulkhead includes at least one clamp for retaining the liner disposed between the articulation and the membrane.

In accordance with another aspect the articulation includes a mobile part an axis of which when in a rest position is in a plane of the main surface of the membrane.

In accordance with another aspect the bulkhead is shaped to be radially positioned by a pivot connection with a fuselage of the aircraft.

The invention also has for object an aircraft including a pressurization bulkhead as described above, said at least one articulation being fixed to the fuselage of the aircraft.

### BRIEF DESCRIPTION OF THE DRAWINGS

Other features, details and advantages will become apparent on reading the following detailed description and examining the appended drawings, in which:

FIG. 1 is a schematic side view of an aircraft of which the location for a pressurization bulkhead according to the present invention is seen as if by transparency.

FIG. 2 is a schematic perspective view from the rear of a fuselage of the aircraft from FIG. 1 open at the location intended to receive the pressurization bulkhead according to the present invention.

FIG. 3 is a schematic perspective view from the front of a detail of FIG. 2.

FIG. 4 is a schematic perspective view from the front of a pressurization bulkhead according to a first embodiment of the invention.

FIG. 5 is a front view of the bulkhead from FIG. 4.

FIG. 6 is a schematic perspective view from the rear of the bulkhead from FIG. 4.

FIG. 7 is a rear view of the bulkhead from FIG. 4.

FIG. 8 is a schematic perspective view of an articulation of the pressurization bulkhead from FIG. 4.

FIG. 9 is a perspective view of the articulation from FIG. 8 provided with a sealing liner.

FIG. 10 is a schematic side view of the articulation from FIG. 9.

FIG. 11 is a schematic perspective view from the front of a pressurization bulkhead according to a second embodiment of the invention.

FIG. 12 is a front view of the bulkhead from FIG. 11.

FIG. 13 is a schematic perspective view from the rear of the bulkhead from FIG. 11.

FIG. 14 is a rear view of the bulkhead from FIG. 11.

FIG. 15 is a schematic perspective view of an articulation of the pressurization bulkhead from FIG. 11.

FIG. 16 is a schematic exploded perspective view of the layers of a membrane of the pressurization bulkhead from FIG. 11.

FIG. 17 is a schematic rear view of the articulation from FIG. 15 rigidly attached to the membrane from FIG. 16.

### DETAILED DESCRIPTION OF THE PREFERRED EMBODIMENTS

The examples and the associated conditions described in detail here are mainly intended to assist the reader to understand the principles of the present invention and not to limit its scope to these specific examples and conditions. It is to be understood that the person skilled in the art can conceive of various arrangements that, although they are not explicitly described or represented here, nevertheless incorporate the principles of the present invention and are included within its spirit and its scope.

Furthermore to facilitate understanding it the following description may describe somewhat simplified embodiments of the present invention. As the person skilled in the art understands other embodiments of the present invention can be of greater complexity.

In some cases examples of modifications of the present invention may also be described. This is merely intended as an aid to understanding the present invention and again not to define the scope of or to establish the limits of the present invention. These modifications do not constitute an exhaustive list and the person skilled in the art could make other modifications remaining within the scope of the present invention.

Furthermore all declarations hereinafter relating to the principles, aspects and embodiments of the present invention and specific examples thereof aim to encompass both structural and functional equivalents thereof, whether known at present or developed in the future.

An orthonormal frame of reference (X, Y, Z) is depicted in the figures to simplify understanding the description of the present invention. The direction Z corresponds to a vertical direction (the yaw axis), the direction X corresponds to a longitudinal direction of the aircraft (the roll axis) and the direction Y corresponds to a transverse direction (the pitch axis).

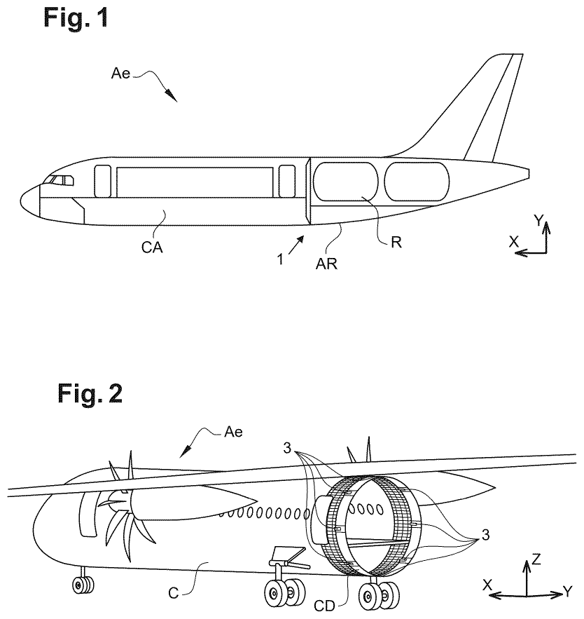

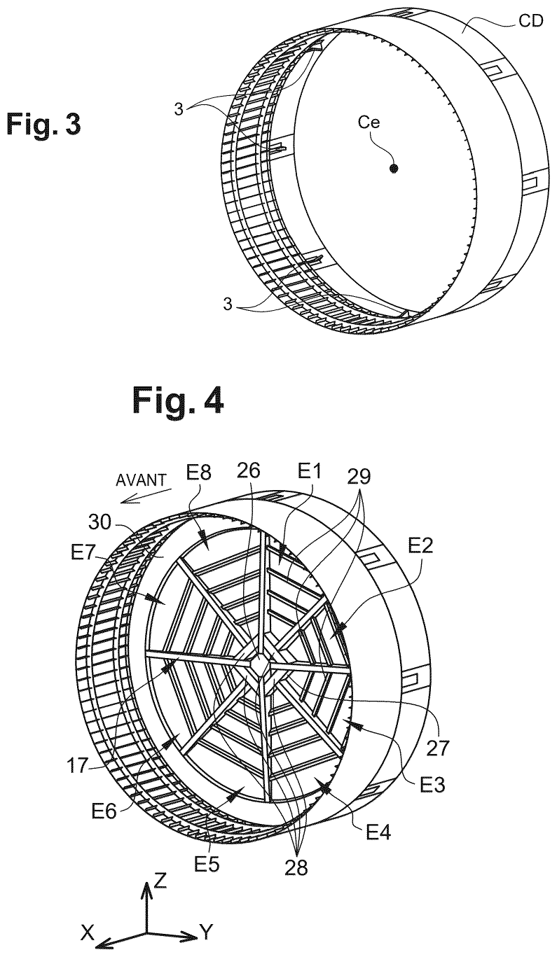

The invention has for object a pressurization bulkhead referenced 1 in the figures for an aircraft Ae seen in FIGS. 1 and 2. The aircraft Ae is for example propelled by hydrogen and includes at least one tank R.

The pressurization bulkhead 1 forms a barrier between the cabin CA of the aircraft and a rear part AR of the aircraft in which each hydrogen tank R is housed. The cabin CA is pressurized in flight, unlike the rear part AR.

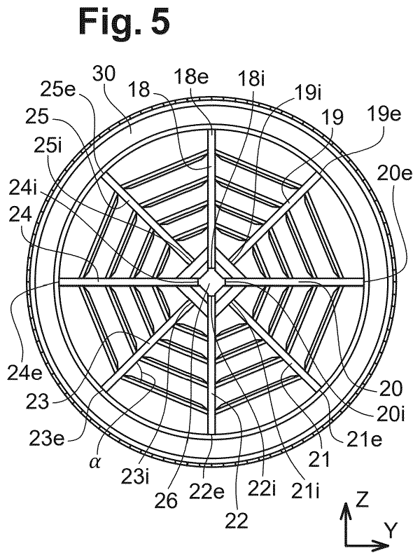

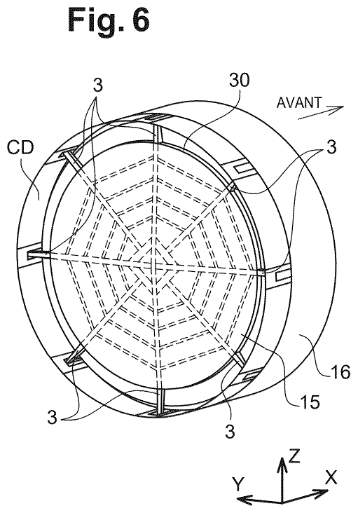

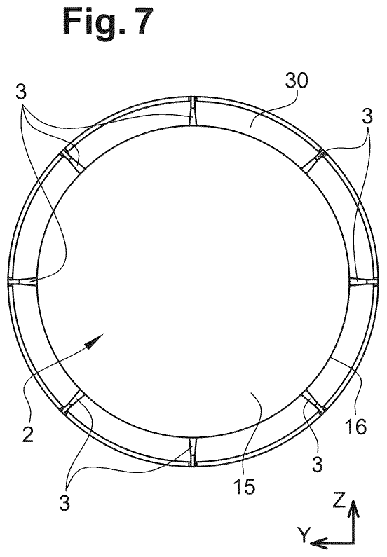

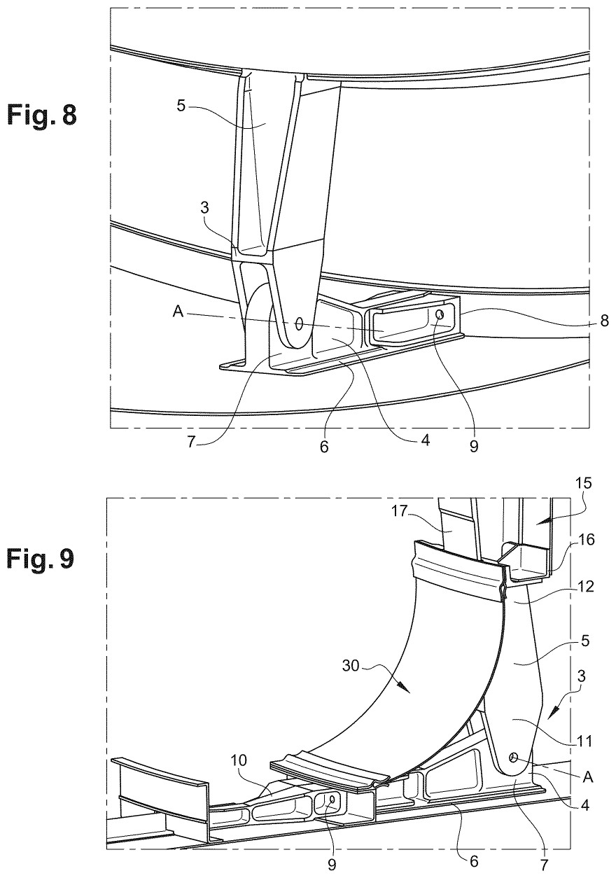

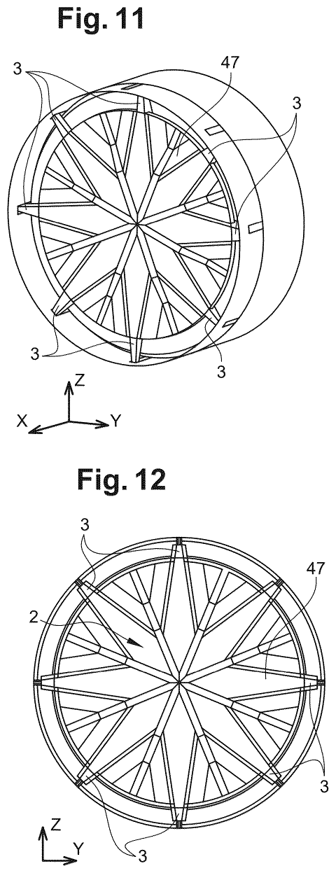

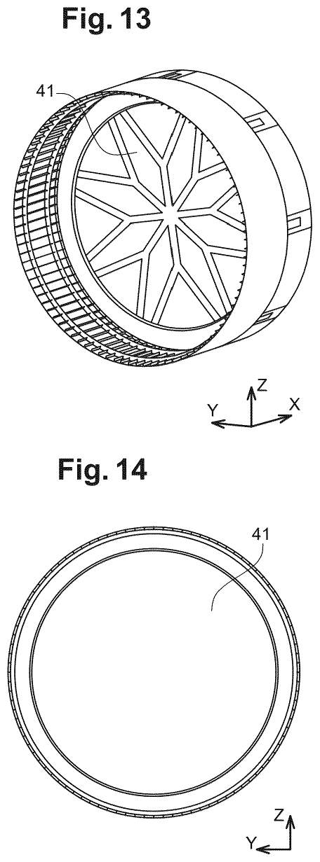

The pressurization bulkhead 1 includes a membrane 2 and at least one articulation 3 and is described in two embodiments respectively with reference to FIGS. 4 to 7 and to FIGS. 11 to 14. Said at least one articulation 3 provides a degree of freedom between the bulkhead 1 and the fuselage of the aircraft Ae that enables transmission of loads in the direction X from the bulkhead 1 to the fuselage.

In the embodiments depicted and in a non-limiting manner the bulkhead 1 includes eight regularly spaced articulations 3. Each articulation 3 is for example a pivot connection. The pivot connection makes it possible to eliminate any moment between the bulkhead and the fuselage in the event of pressurization forces on the bulkhead 1.

As emerges from the figures each articulation 3 is rigidly attached to the membrane 2 and to a frame CD of the fuselage of the aircraft Ae.

The articulation 3 includes a fixed part 4 intended to be rigidly attached to the frame CD and a mobile part 5 intended to be rigidly attached to the membrane 2. The mobile part 5 is able to pivot about an axis A that is for example tangential to the membrane.

The fixed part 4 includes a base 6 that has an elongate shape through one longitudinal end 7 of which the axis A passes and the other longitudinal end 8 of which includes an orifice 9 for a bolt to pass through for rigidly attaching the articulation 3 to a supplementary connecting element 10. The element 10 and the articulation 3 are screwed to one another, a C-profile bracket sealing the rigid attachment. The base 6 is fixed to the frame CD.

The mobile part 5 extends between an end 11 through which the axis A passes and an end 12. The membrane 2 is inserted in a housing in the end 12 as described in detail later.

In the embodiments depicted each of the articulations 3 is fixed by its fixed part 4 to the frame CD. For example the articulations are regularly spaced relative to one another. In the figures two adjacent articulations are at an angle of 45° to a center Ce of the frame CD in a plane YZ. The invention is obviously not limited to this configuration and the angle between two articulations depends on the number of radial bars chosen.

The interface forming the axis A advantageously includes an elastomer, which increases the tolerances.

The first embodiment of the invention made of metal or composite material is described in detail next.

The membrane 2 includes a plane skin 15 of disk shape. The plane skin 15 extends mainly in a plane (Y, Z) when the bulkhead is installed in the aircraft Ae, coaxial with the center Ce of the frame CD. In the plane (Y, Z) the plane shape saves space and also makes it possible to move the hydrogen tanks toward the center of the aircraft.

The skin 15 is tensioned by its rigid attachment to each of the articulations 3.

In FIG. 9 the pressurization bulkhead 1 also includes a structure 17 reinforcing the pressurization bulkhead 1.

The reinforcing structure 17 includes at least one radial bar rigidly attached to one of the articulations 3. For example the reinforcement structure includes eight radial bars 18 to 25, each of the bars 18 to 25 being rigidly attached to a respective articulation 3 at an end called the external end and respectively referenced 18e to 25e.

In the embodiment depicted the reinforcing structure includes among the radial bars four main radial bars 18, 20, 22 and 24 and four secondary radial bars 19, 21, 23 and 25. The main radial bars extend as far as a center 26 of the reinforcing structure 17 at an end called the internal end and referenced 18i, 20i, 22i and 24i. Two successive main bars are at an angle of 90° to the center of the reinforcing structure 17.

The reinforcing structure 17 also includes a central square 27 with four rods 28 around the center 26 of the reinforcing structure 17. Each rod 28 of the central square 27 is fixed to two main radial bars. The secondary radial bars 19, 21, 23, 25 are rigidly attached at their internal end 19i, 21i, 23i, 25i to a respective rod 28 of the central square 27, for example in the middle thereof.

The reinforcing structure 17 includes at least one bar connecting a main radial bar to a secondary radial bar. In the embodiment depicted the reinforcing structure 17 includes eight assemblies E1 to E8 of four connecting bars 29, the connecting bars in an assembly extending parallel to one another. Each assembly of four bars lies between two respective main and secondary radial bars. Each bar 29 of the assembly E1 therefore lies between the main radial bar 18 and the secondary radial bar 19, each bar 29 of the assembly E2 lies between the secondary radial bar 19 and the main radial bar 20, each bar 29 of the assembly E3 lies between the main radial bar 20 and the secondary radial bar 21, each bar 29 of the assembly E4 lies between the secondary radial bar 21 and the main radial bar 22, each bar 29 of the assembly E5 lies between the main radial bar 22 and the secondary radial bar 23, each bar 29 of the assembly E6 lies between the secondary radial bar 23 and the main radial bar 24, each bar 29 of the assembly E7 lies between the main radial bar 24 and the secondary radial bar 25, and each bar 29 of the assembly E8 lies between the secondary radial bar 25 and the main radial bar 18. An internal angle α between a radial bar and a connecting bar is between 60° and 85° for example.

The reinforcing structure 17 enables improved behavior of the pressurization bulkhead 1 in the event of a shock, the radial bars 18 to 25 extending the articulations 3 enabling the load to be transmitted to the reinforcing structure, which absorbs pressurization forces by deformation. The reinforcing structure 17 imparts to the pressurization bulkhead the capacity to introduce only forces oriented in the direction X in the frame CD (i.e., forces directly introduced in the sense of the skin, with no moment).

As also emerges from the figures the pressurization bulkhead 1 includes a sealing coating 30 also called a sealing liner. The liner 30 is advantageously made of a flexible material, for example a fiber or woven material coated in an elastomer having a ring at the ends. The liner 30 is disposed in the space between the membrane 2 and the frame CD so that the bulkhead 1 is continuous (with no orifices) between the frame CD and the membrane 2. The bulkhead 1 therefore enables a pressure difference to be maintained in flight between the pressurized cabin CA and the unpressurized rear area AR. Note also that the liner allows movement of the ring 5 relative to the frame CD without introducing moments at the periphery.

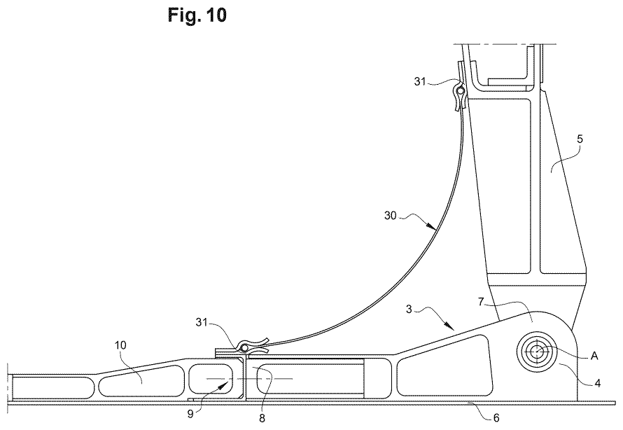

As seen more particularly in FIGS. 9 and 10 the liner 30 is attached between two clips, a first clip 31 fixed to the mobile end 15 of the articulation 3 and a second clip 32 fixed to the supplementary connecting element 10.

The composite material second embodiment is described now.

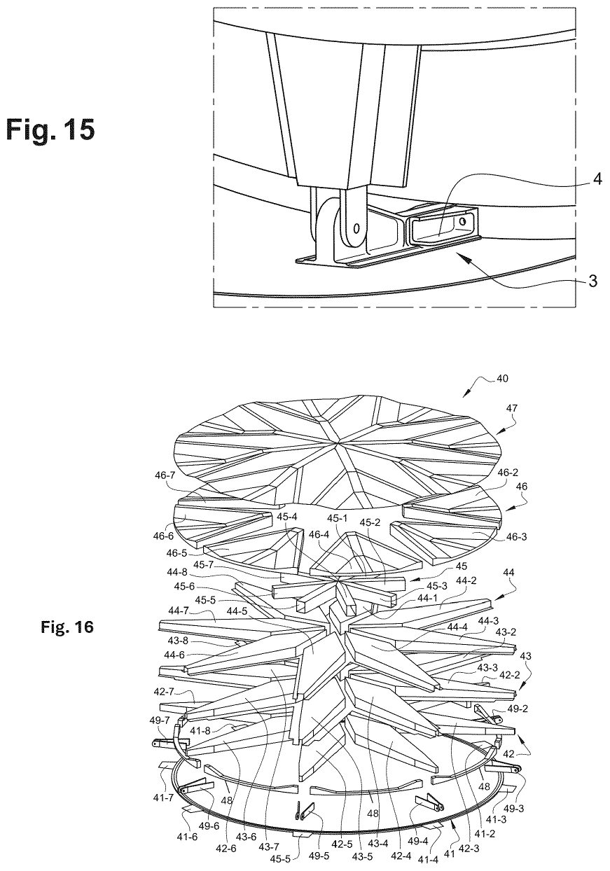

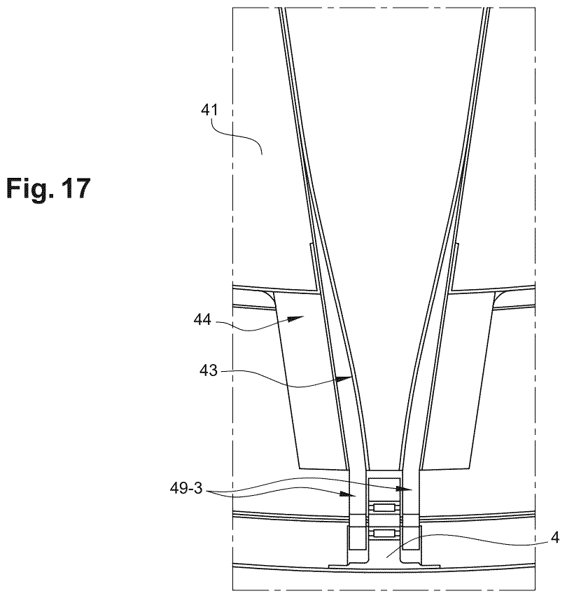

As can be seen in FIGS. 9 to 17 the membrane 2 includes a succession 40 of stacked layers called a carbon fiber reinforced polymer (CFRP) sandwich.

The sandwich 40 includes a first layer 41 called the pressure layer of CFRP composite material. The pressure layer 41 has a disk shape with lugs that project from the disk. In the embodiment depicted the layer includes eight lugs 41-1 to 41-8 that are regularly spaced and at an angle of 45° to a center C of the pressure layer.

The sandwich 40 includes at least one foam or cardboard honeycomb layer 42. The layer 42 has the shape of a star with eight branches 42-1 to 42-8.

The sandwich 40 includes a second layer 43 of CFRP composite material in the shape of a star with eight branches 43-1 to 43-8 and a third layer 44 of CFRP composite material in the shape of a star with eight branches 44-1 to 44-8.

The layers 41, 42 and 43 are coaxial with the layer 41 and their branches are respectively placed one on the other.

The sandwich 40 has a center 45 with eight branches 45-1 to 45-8, each of the branches being inserted between a respective two branches of the star shape of the layer 43.

The sandwich 40 includes a foam or cardboard honeycomb layer 46. The layer 46 is discontinuous and includes eight sectors 46-1 to 46-8 complementary to the branches of the layer 42 so as together to form a solid disk.

The sandwich 40 also includes a layer 47 of CFRP composite material in the shape of a disk with ribs in a star arrangement.

As can be seen in FIG. 16 the bulkhead 1 also includes eight annular members 48 of circular arc shape between which the tips of the star shapes of the layers 42, 43 and 44 are engaged. The bulkhead 1 also includes eight inserts 49-1 to 49-8 each including two V-shape blades. Each of the inserts retains one of the branches of the star shapes between its two blades and the lugs 41-1 to 41-8 cover each of the inserts 49.

In this embodiment the inserts 49-1 to 49-8 form the mobile parts 5 of the articulation 3. The fixed part 4 is unchanged relative to the fixed part 4 of the first embodiment.

Likewise the bulkhead 1 according to the second embodiment includes a liner 30 identical to that of the first embodiment.

Note that the membrane 2 is also plane in this second embodiment. The sandwich 40 extends mainly in a plane (Y, Z) when the bulkhead is installed in the aircraft Ae, coaxial with the center Ce of the frame CD. The plane shape in the plane (Y, Z) produces a saving of space and also enables the hydrogen tanks to be moved closer to the center of the aircraft.

The composite material has better mechanical behavior in traction (application of tension to the fibers) than in compression (only the matrix accounts for the coherence of the material). Upon application of pressure to the plane bulkhead global flexing of the lens occurs with a zone of compression loading on the pressurized surface and traction loading on the unpressurized surface (the rear of the bulkhead). It is therefore advantageous for the composite structure (beam) to work in traction in the unpressurized zone.

The sandwich 40 is simple to manufacture because of the presence of the layers of foam or honeycomb cardboard.

As emerges from the foregoing description the flexibility of the bulkhead 1 ensures that it does not rupture because of the effect of pressurization, it is simple to fit, optimizing the final assembly line, and it facilitates access to the interior of the cabin, the liner producing a pressurization barrier, and the plane surface reducing the bulk and therefore contributing to the limitation of the length of the aircraft.

Modifications and improvements to the embodiments of the present invention described above may suggest themselves to the person skilled in the art. In particular the embodiments and variants described are combinable if they are not incompatible. The description hereinabove is illustrative by means of examples rather than limitative. The scope of the present invention is therefore limited only by the scope of the claims below.

What is claimed is:

1. A pressurization bulkhead for an aircraft, comprising:
a membrane having a plane main surface and at least one articulation for connecting the membrane to the fuselage of the aircraft.

2. The pressurization bulkhead according to claim 1, wherein said at least one articulation is a pivot.

3. The pressurization bulkhead according to claim 2, further comprising a flexible liner rigidly attached to said at least one articulation and extending between the membrane and said at least one articulation.

4. The pressurization bulkhead according to claim 3, wherein the membrane has a circular contour, the bulkhead including at least two articulations regularly distributed around said circular contour.

5. The pressurization bulkhead according to claim 4 further comprising eight articulations regularly distributed around said circular contour.

6. The pressurization bulkhead according to claim 5 further comprising at least one radial reinforcement.

7. The pressurization bulkhead according to claim 6 further comprising at least one radial reinforcement associated with each articulation.

8. The pressurization bulkhead according to claim 7, wherein each radial reinforcement is a metal or composite material bar.

9. The pressurization bulkhead according to claim 8, wherein the membrane includes a stack of layers comprising at least one layer of honeycomb cardboard and/or of foam and at least one layer of composite material.

10. The pressurization bulkhead according to claim 9 further comprising at least one clip for retaining the liner disposed between the articulation and the membrane.

11. The pressurization bulkhead according to claim 10, wherein the articulation includes a mobile part an axis of which in a rest position is in a plane of the main surface of the membrane.

12. The pressurization bulkhead according to claim 1 conformed to be positioned radially with a pivot connection to a fuselage of the aircraft.

13. An aircraft including a pressurization bulkhead as claimed in claim 1, said at least one articulation being fixed to the fuselage of the aircraft.
